(19) United States
(12) Patent Application Publication
(10) Pub. No.: US 2017/0081891 A1
(43) Pub. Date: Mar. 23, 2017

(54) BEARING ASSEMBLY FOR A DOOR

(71) Applicant: HETTICH-ONI GMBH & CO. KG, Vlotho (DE)

(72) Inventors: Eduard THIELMANN, Lage (DE); Andreas KLEEMANN, Kalletal (DE); Martin NORDIEKER, Hüllhorst (DE); Alexander BUSCHMANN, Herford (DE)

(21) Appl. No.: 15/311,352

(22) PCT Filed: May 13, 2015
(86) PCT No.: PCT/EP2015/060583

§ 371 Date: Nov. 15, 2016

(30) Foreign Application Priority Data
May 15, 2014 (DE) 10 2014 106 876.9

(51) Int. Cl. E05F 1/14; E05F 1/12; F25D 23/02; E05D 7/081

(52) U.S. Cl. CPC E05F 1/14; E05D 7/081; E05F 1/1253; F25D 23/028; E05Y 2900/31; F25D 2323/024

(57) ABSTRACT

The invention relates to a bearing assembly for a door of an item of furniture or household appliance, in particular for refrigerators or freezers, comprising: a bearing element, that can rotate about a bearing axis, for rotatably mounting the door on a body of the item of furniture or household appliance; a closing system, attached to the body of the item of furniture or household appliance or to the door, by means of which the door can be moved through a certain pivot range in the closing direction using a drive part, said closing system having the drive part and a first rotary element which has an axis of rotation that is substantially parallel to the bearing axis of the door and which supports a rotary movement of the door about the bearing axis, wherein the first rotary element and the door are connected to one another via a compensation system for compensating for a misalignment between an axis of rotation of the first rotary element and the bearing axis of the door.

### CROSS REFERENCE TO RELATED APPLICATIONS

This application is a U.S. nationalization under 35 U.S.C. §371 of International Application No. PCT/EP2015/060583, filed May 13, 2015, which claims priority to German Application No. 102014106876.9 filed May 15, 2014.

### BACKGROUND AND SUMMARY OF THE DISCLOSURE

The present disclosure relates to a bearing assembly for a door of an item of furniture or domestic appliance, for example, for a refrigerator or freezer.

A swinging door of an item of furniture for a domestic appliance, which is drivable using a door closer or swinging door drive, is known from EP 2 020 477. The door closer has a driveshaft in this case, which interacts with the swing door so that a rotation of the driveshaft causes a pivot of the swing door. The axis of rotation of this driveshaft is identical to the axis of rotation of the swing door in this case.

This rigid connection between swing door and door closer has the disadvantage in this case that even a small offset of the driveshaft out of the axis of rotation of the swing door can result in wear of the door hinges and/or the driveshaft of the door closer.

A higher friction which is thus induced within the connection between swing door and door closer additionally requires greater forces for driving the swing door, so that an offset between the axes of rotation of the door closer and the swing door can sometimes have the result that the force of the door closer is insufficient to completely close the door.

Accordingly, the installation of the door closer on item of furniture or domestic appliance also has to be performed extremely exactly, to preclude such an axial displacement as much as possible.

The present disclosure illustrates and describes a bearing assembly for a door of an item of furniture or domestic appliance, by which simple and flexible positioning of a closing device for a door is enabled.

A bearing assembly according to the disclosure has a bearing element for the rotatable mounting of the door on a body of the item of furniture or domestic appliance about a bearing axis and a closing device fastened on a body of the item of furniture or domestic appliance or the door, by means of which the door is movable by a drive part over a pivot range in the closing direction or opening direction, wherein the closing device has the drive part and a first rotational element, which absorbs a rotational movement of the door about the bearing axis, having an axis of rotation substantially parallel to the bearing axis of the door. This first rotational element is connected to the door via a compensation device for compensating for a length offset and/or angle offset between the axis of rotation of the first rotational element and the bearing axis of the door.

A compensation of a length offset and/or angle offset between the axis of rotation of the door and a first rotational element, which absorbs the rotational movement, and using which the closing device for closing or opening the door is activated, is thus enabled, which is accompanied by various advantages.

On the one hand, a compensation of tolerances and displacements is thus enabled, for example, due to wear of the door hinges or sinking of the door which result over time.

Furthermore, the bearing assembly according to the disclosure enables the closing device, with corresponding dimensioning of the compensation device, to be attached to the body of the item of furniture or domestic appliance, without having to ensure a precise correspondence of the axes of rotation of door and rotational element of the closing device.

According to the disclosure, a closing device can be used on furniture or domestic appliances having different suspensions of the door, wherein only the compensation device is to be adapted to the mechanism of the door suspension.

In an embodiment, the compensation device has a driver, which can be coupled to the first rotational element in a rotationally-fixed manner and moves the door in the closing direction and/or opening direction, and by which a transmission of the rotational movement from one of the rotational elements by the closing device into the door and vice versa is provided. Such a driver enables the compensation of tolerances of the displacements or an angle offset of the bearing axis of the door in relation to the axis of rotation of the closing device.

In an embodiment, the driver thus has a bolt, which can be coupled in a rotationally-fixed manner to the first rotational element, and a driver arm, which is held on the bolt so it can be tilted in an angle range between 75° and 105° in relation to the axis of rotation on the first rotational element. A compensation for vertical sinking of the door is also enabled using such a driver.

A tilting edge, on which the driver arm can be tilted in the above-mentioned angle range, may be used in this case to compensate for alignment errors and angle offsets.

In another embodiment, the driver is insertable into a recess of the door. This recess in the door is preferably dimensioned larger in this case than an insert part of the driver, to permit tilting of the driver as described above. A displacement of the insert part in relation to the door is also provided in this case, to compensate for corresponding alignment errors.

In the reverse case, of course, a protruding part of the door, for example, a bolt fixed on or in the door, can be coupled to the driver by protruding into an opening of the driver, for example.

In a further embodiment, the driver is designed as a bolt which can be accommodated using the bearing element of the door in a rotationally-fixed manner. The bearing element is preferably designed in this case as a hinge having a passage borehole for the driver, wherein the bolt is accommodated in a rotationally-fixed manner in the door recess.

To also enable an angle offset between the axis of rotation of the door and the first rotational element in this variant, an end part of the driver, which protrudes into the first rotational element, can be tilted in a predetermined angle about the axis of rotation of the first rotational element. This may be achieved by forming the end part of the driver in the form of a spherical head. The end part of the driver is mounted in a formfitting manner in the first rotational element in the rotational direction of the first rotational element in this case, wherein circumferential contact surfaces of the end part of the driver are designed as spherical. In this manner, the driver is also capable of maintaining a rotationally-fixed connection to the first rotational element in the slightly tilted state.

Further possibilities for coupling the driver to the door are also conceivable. The driver can be fastened at the bottom/top on the end face of the refrigerator door, or only plugged thereon or inserted therein. Coupling to the inner surface of the door also suggests itself, without the external appearance of the item of furniture or domestic appliance changing.

In another embodiment, the compensation device has at least one second rotational element, which is coupled to the first rotational element and transmits the rotational movement, wherein the second rotational element is arranged offset in relation to the first rotational element, in a plane substantially parallel to the bearing axis.

In the case of the design of the compensation device having the second rotational element, the above-mentioned driver is coupled to the second rotational element.

The transmission of the rotational movement of the door can be transmitted in various ways using such a second rotational element. It is thus conceivable to connect the rotational elements to one another via a toothed belt, for example.

Bridging larger distances between the two rotational elements is thus enabled, so that the closing device can be positioned further to the rear, i.e., in the direction of the rear wall of the item of furniture or domestic appliance, preferably on the upper side thereof, with correspondingly long toothed belt, for example.

If the closing device is attached to the door, the transmission of the rotational element to a second rotational element can be used for the purpose of positioning the closing device at a location of the door at which more structural space is available for this purpose than is present close to the bearing point in relation to the body.

It is also conceivable to design the two rotational elements as gearwheels, so that the rotational movement of the door is transmitted to the closing device by interlocking of the teeth of the rotational elements designed as gearwheels.

Depending on the control of the closing device, it is also conceivable to insert a third gearwheel as an intermediate element between the first and second rotational elements designed as gearwheels, to keep the rotational direction of the first and second rotational elements the same.

The axis of rotation of the second rotational element is preferably identical to the bearing axis of the door in this case. Structural deviations/tolerances can be compensated for as described above by the use of an above-mentioned driver.

Because only very little structural space is required for the transmission of the rotational movement of the second rotational element, it is thus made possible in a simple manner to design a housing which encloses the closing device and/or the compensation device so that it does not protrude beyond the edge of the door of the item of furniture or domestic appliance, if the closing device and the compensation device are attached on or below the body of the item of furniture or domestic appliance.

In a further embodiment, a damper for damping a pivot movement of the door about at least one pivot range, which is coupled to the first rotational element, is accommodated in the closing device. In addition to reliable closing, damping of the door during the opening and/or closing of the door is thus enabled.

A curve guide for the movement of the closing device and/or the damper may be arranged on the first rotational element to transmit the rotational element from the drive part of the closing device to the first rotational element and/or from the first rotational element of a drive part of the closing device and optionally to the damper.

Setting the forces for closing or opening or for damping accurately is enabled by the use of such a curve guide, because a rigid coupling is no longer provided between door closing device and/or damper, but rather this coupling takes place via one or more curve guides, which act on the closing device and/or the damper during the pivoting of the door. Both the closing device and also the damper can be pre-tensioned against the curve guide in this case by a spring.

The bearing assembly according to the disclosure is usable in particular for items of furniture or domestic appliances, for example, for refrigerators and freezers.

### BRIEF DESCRIPTION OF THE DRAWINGS

FIG. 1 shows a perspective view of a refrigerator having a bearing assembly according to the present disclosure,

FIG. 2 shows a top view of the bearing assembly arranged on the refrigerator,

FIG. 3 shows a top view of a closing device of the bearing assembly having additional damper contained in the closing device,

FIG. 4 shows a sectional view through the bearing assembly in a plane of section identified with IV in FIG. 2,

FIGS. 5 to 8 show multiple views of an embodiment of a bearing assembly according to the present disclosure having a tiltable driver,

FIG. 9 shows an alternative embodiment variant of a bearing assembly according to the present disclosure having driver accommodated in the bearing element of the door,

FIG. 10 shows a sectional view of an embodiment variant of a bearing assembly according to the present disclosure with illustration of a driver provided with a spherical end,

FIG. 11 shows a top view of the spherical end of the driver from FIG. 10, and

FIGS. 12 to 15 show top views of different embodiment variants of a bearing assembly according to the present disclosure having at least one second rotational element for transmitting the rotational movement of the door to the first rotational element of the closing device.

### DETAILED DESCRIPTION OF THE DRAWINGS

In the following description of the figures, terms such as above, below, left, right, front, rear, etc. exclusively relate to the illustration and position, which are selected by way of example in the respective figures, of the bearing assembly, the door, the closing device, the rotational elements, the driver, and the like. These terms are not to be understood as restrictive, that is, these references may change due to various operating positions or mirror-symmetrical design or the like.

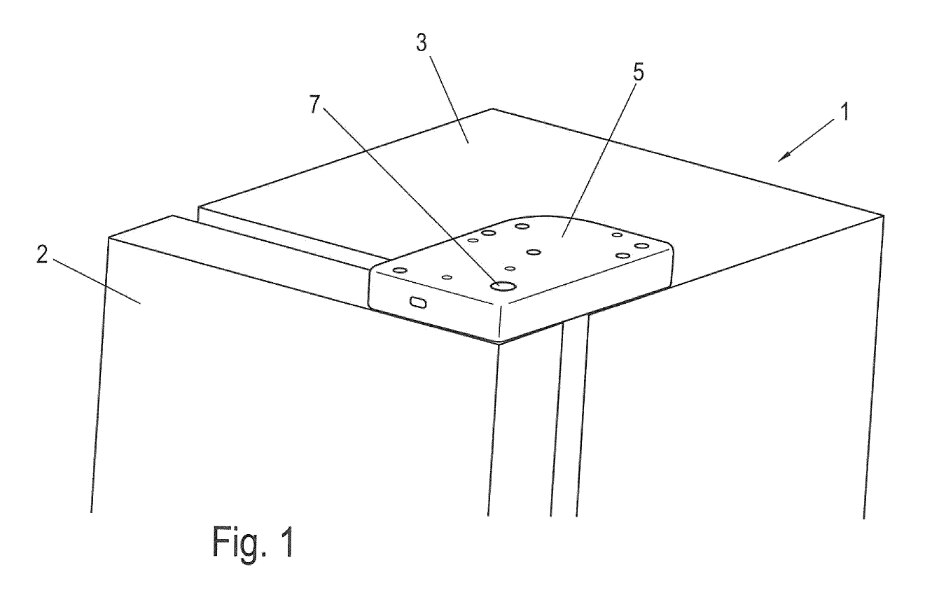

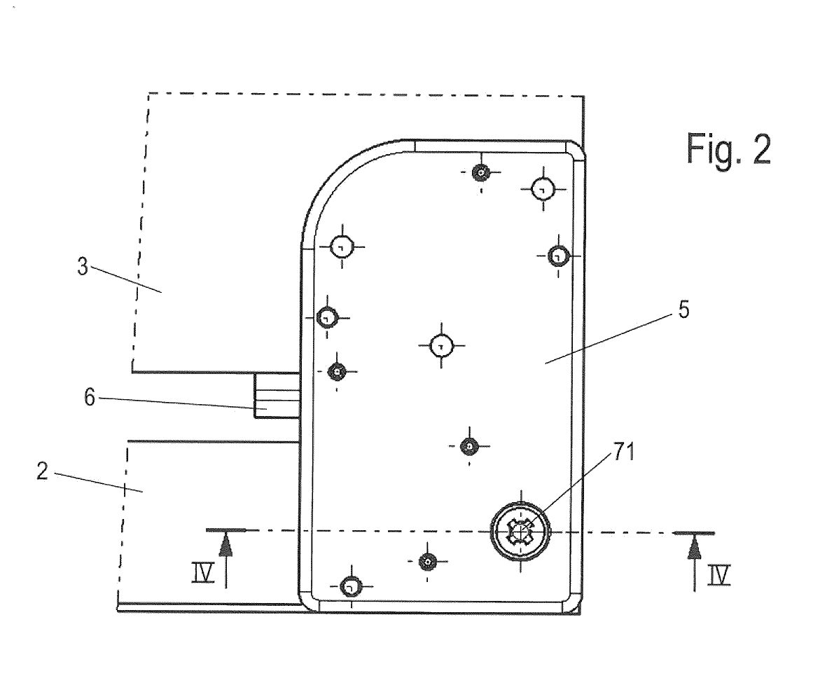

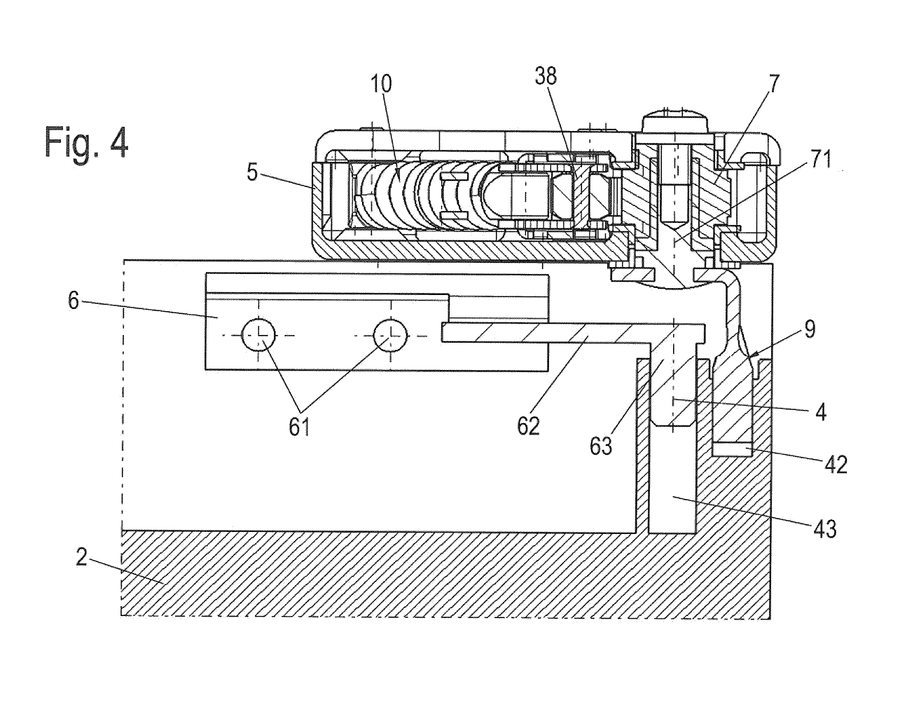

A domestic appliance in the form of a refrigerator or freezer is identified as a whole with the reference numeral 1 in FIG. 1. This refrigerator or freezer 1 comprises a body 3, on which a door 2 is rotatably mounted. A bearing element 6, which is fastened on the body 3 of the domestic appliance 1, as shown, for example, in FIG. 4 and using which the door 2 is secured so it is rotatable on the body 3 of the domestic appliance 1, is used for mounting the door 2.

A closing device 10, by means of which the door 2 is movable by a drive part over a specific pivot range in the closing direction, is arranged in the housing, which is identified with the reference numeral 5 in FIG. 1. A force accumulator 11, for example, a spring designed as a compression spring, may be used in this case as the drive part.

Other embodiments of the drive part are also conceivable. The drive part can thus also be designed, for example, as an electrical drive part, in particular as an electric motor.

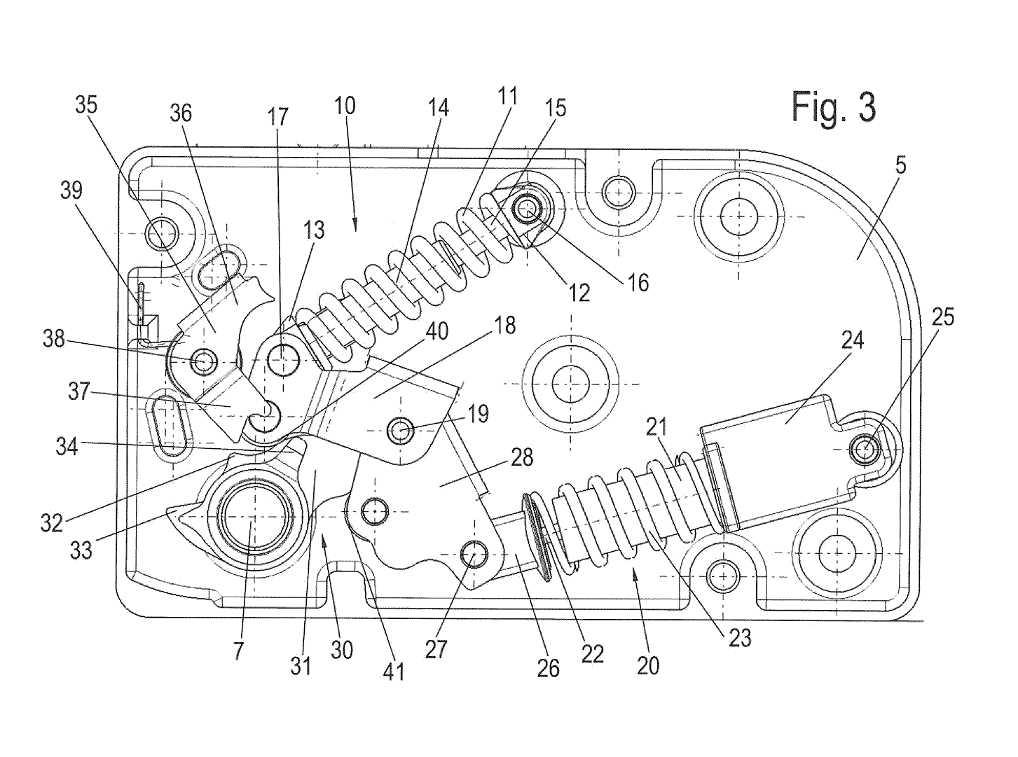

One preferred embodiment of this closing device 10 is shown in FIG. 3. In the case of the closing device shown in FIG. 3, which will also be described in greater detail hereafter, a damper 20 is accommodated in addition to the closing device 10, wherein both the closing device 10 and also the damper device 20 are coupled to a first rotational element 7, which absorbs a rotational movement of the door about the bearing axis 4, and which has an axis of rotation 71 substantially parallel to the bearing axis 4 of the door 2.

To transmit a rotational movement from the first rotational element 7 to the door 2 and/or vice versa, the first rotational element 7 and the door 2 are connected to one another via a compensation device to compensate for an offset or angle offset between the axis of rotation 71 of the first rotational element 7 and the bearing axis 4 of the door. A first embodiment of such a compensation device is shown in FIG. 4. The compensation device has a driver 9 here, which is attachable to the door 2 and can be coupled to the first rotational element 7 in a rotationally-fixed manner.

As can be seen in FIG. 4, the bearing element 6 is fixed in place on the body 3 of the domestic appliance, for example, screwed to the body using screws 61. A bolt 63, which is inserted into a first recess 43 of the door 2, is arranged on an arm 62, which protrudes in the direction of the door 2, of the bearing element 6 on its end spaced apart from the body 3.

A further such bearing element 6 is fastened on the body 3 in this case in the region of the bottom of the domestic appliance, wherein the bolt 63 protrudes into a bottom opening of the door 2 upward into a corresponding recess 43 (not shown) and thus holds the door so it can be rotationally moved about a bearing axis 4 on the body of the domestic appliance 1.

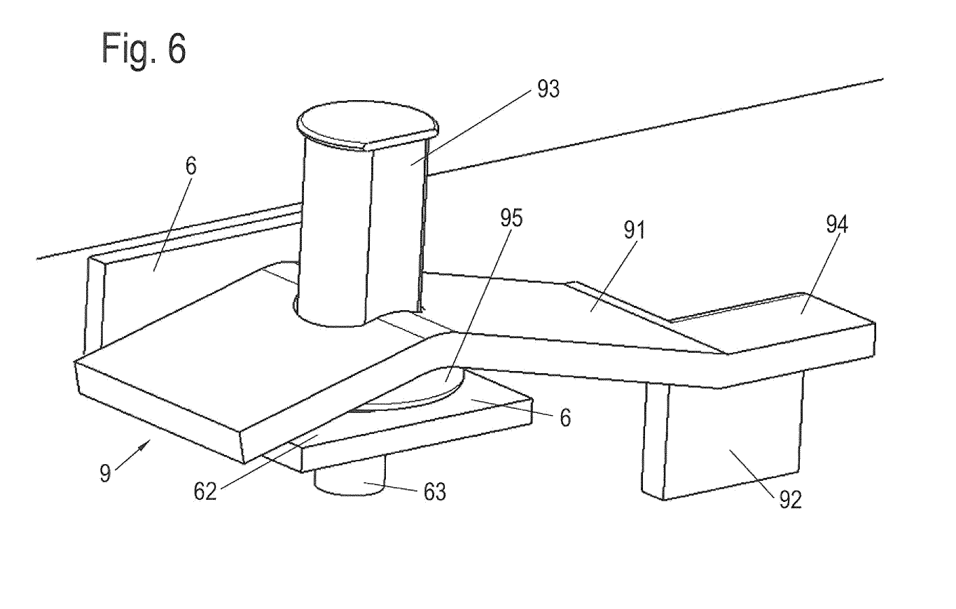

The driver 9 is attached, in particular inserted, in a second recess 42. The part of the driver 9 (shown in FIG. 6) which can be inserted into the recess 42 of the door 2 is secured in a rotationally-fixed manner in the recess 42 of the door 2 in this case.

The second end of the driver 9 is connected in a rotationally-fixed manner to the first rotational element 7 of the closing device 10 in this case. Vertical sinking of the door 2 can be compensated for by the driver 9, which is inserted into the recess 42 of the door, without interrupting the transmission of the rotational movement of the door 2 via the driver 9 to the first rotational element 7 of the closing unit 10.

A possible displacement of the insert part 92 of the driver 9 in relation to the recess 42 of the door 2 is also provided, to compensate for alignment errors of the axis 4 of the door 2 in relation to the axis 71 of the first rotational element 7 or the axis 84 of the second rotational element 8.

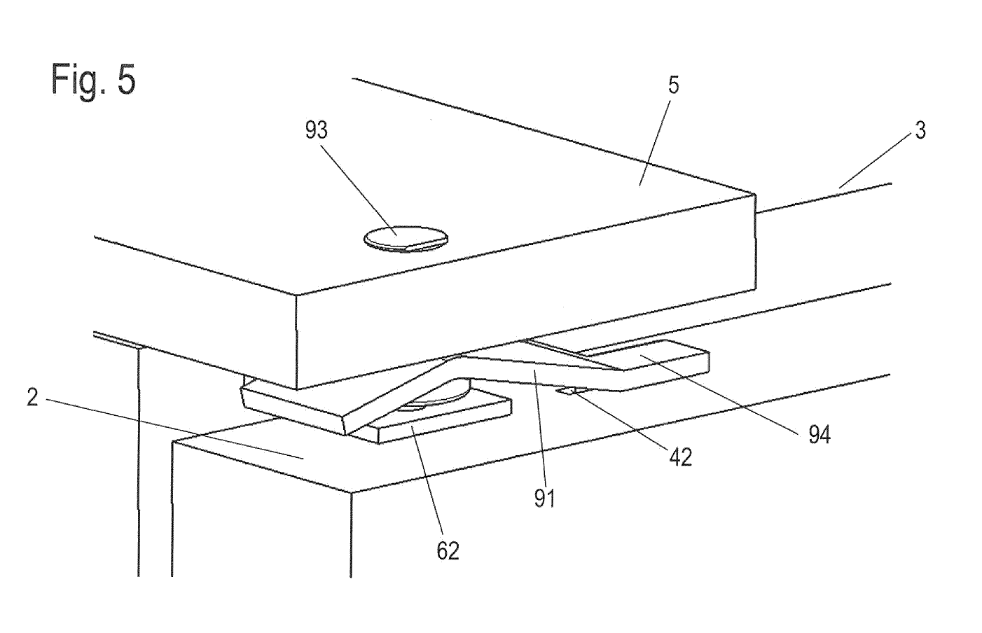

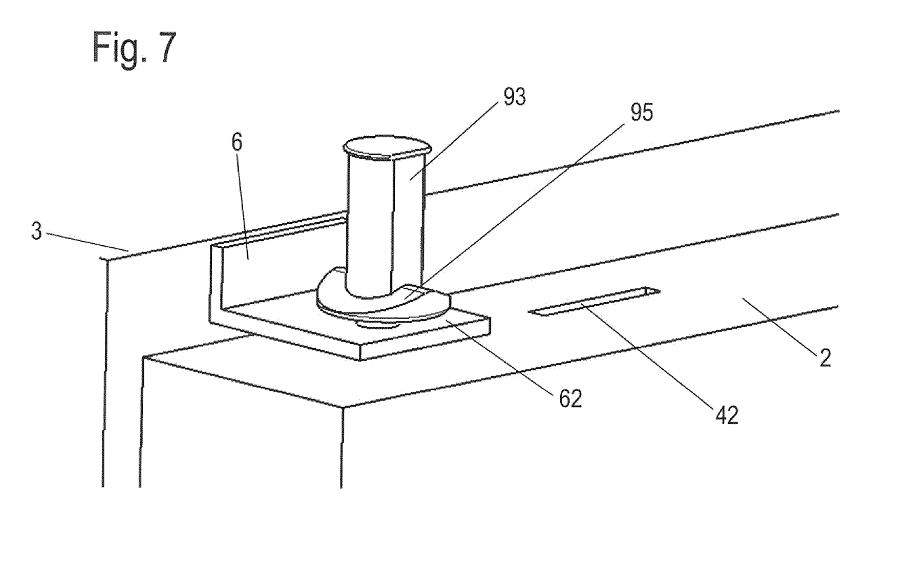

According to an embodiment, shown in FIGS. 5 to 8, the driver 9 has a bolt 93, which can be coupled in a rotationally-fixed manner to the first rotational element 7. The bolt 93 is connected in a rotationally-fixed manner to the first rotational element 7 in this case.

A driver arm 91 of the driver 9 is held so it can be tilted on the bolt 93 in this case in an angle range preferably between 75° and 105° in relation to the axis of rotation 71 of the first rotational element 7. The driver arm 91 is designed in this case, as can be seen in FIGS. 5, 6, and 8, as approximately roof-shaped having two legs arranged at an obtuse angle in relation to one another and rests on a collar 95, which encloses the bolt 93 and is also designed as roof-shaped, wherein the apex of this collar 95 forms a tilting edge for the driver arm 91 and is therefore capable of compensating for an angle offset between the axis of rotation 71 of the first rotational element 7 and the axis of rotation 4 of the door 2.

As shown in FIGS. 6 to 8, an attachment part 94 extends from the roof-shaped driver arm 91, from which a paddle-shaped insert part 92 of the driver is arranged perpendicularly downward, which can be inserted into the recess 42 in the door 2.

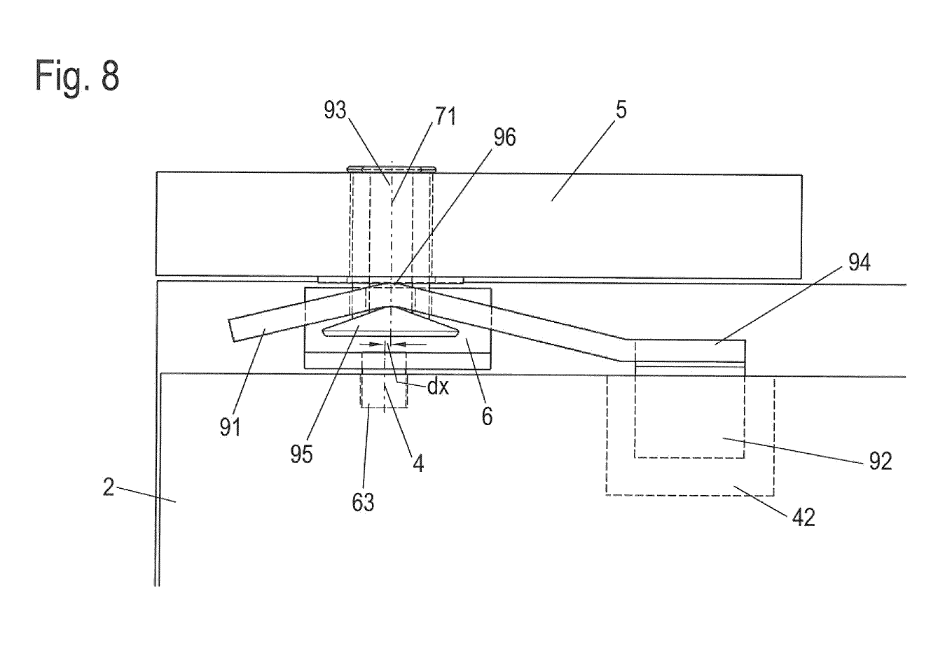

As shown in FIG. 8, this recess 42 is dimensioned larger than the insert part 92 of the driver 9, to also enable a tilting movement and a displacement movement of the driver in the recess 42 of the door 2.

As can furthermore be seen in FIG. 8 and FIG. 4, the bearing element 6, from which an arm 62 extends toward the door 2, is not connected to the driver 9. A bolt 63 extends downward toward the door 2 from the arm 62 of the bearing element 6, this bolt being used as the bearing bolt of the door and being accommodated in the first recess 43 of the door.

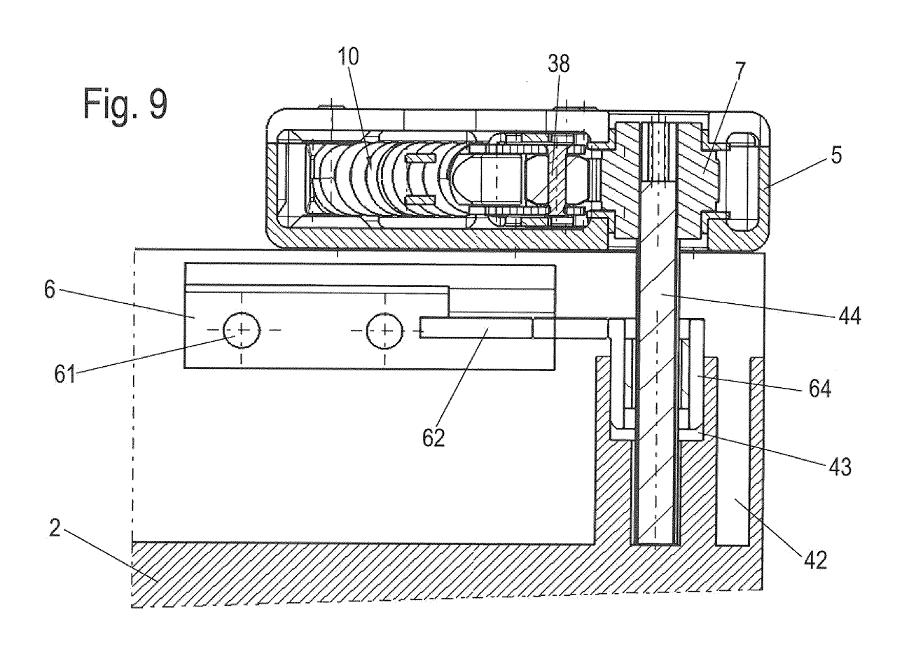

In an alternative embodiment, shown in FIG. 9, the driver 44 is designed as a bolt which can be accommodated in a rotationally-fixed manner in the door 2 in the bearing element 6. For this purpose, a sleeve 64 is provided in the bearing element 6 in the region of the bearing arm 62, which can rotate in the recess 43 of the door. The driver 44 is plugged through the sleeve 64 in this case and is held in a rotationally-fixed manner at one end on the door 2. The internal diameter of the sleeve 64 is dimensioned in this case so that sufficient clearance exists in relation to the driver 44, so that no contact arises between sleeve 64 and driver 44 even upon the occurrence of an alignment error or angle offset. A driver 44 is held in a rotationally-fixed manner in the first rotational element 7 of the closing device 10 at the other end.

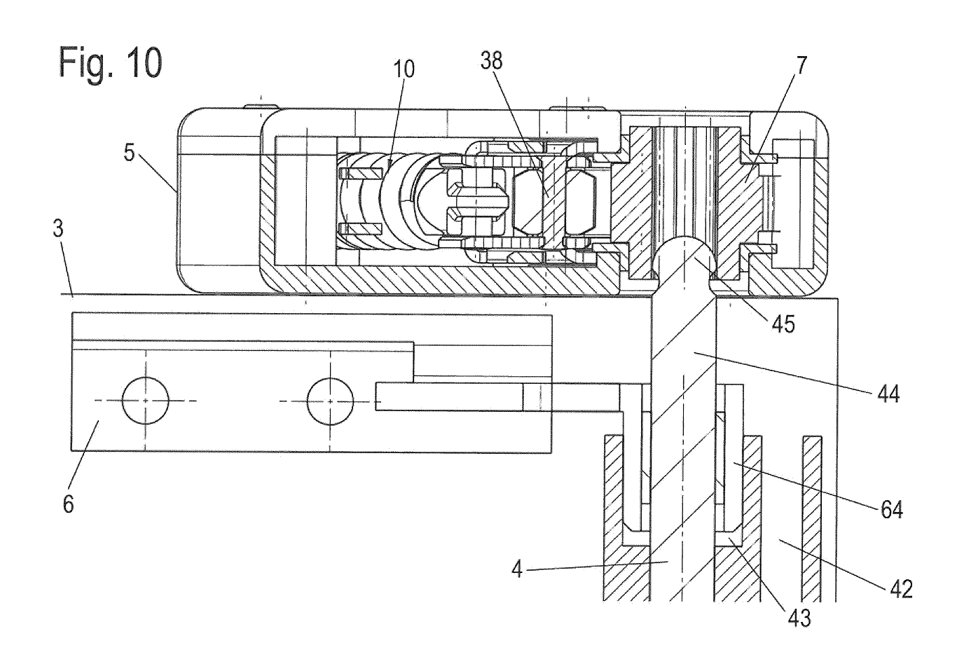

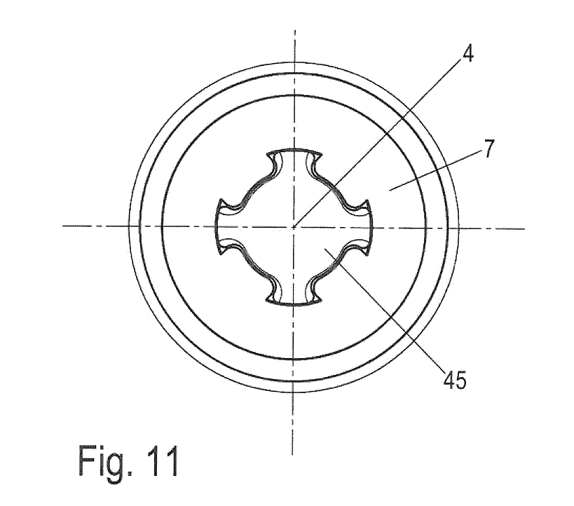

To also enable an angle deviation of the axis of rotation here, as shown in FIGS. 10 and 11, the end 45 of the driver 44, which is held in a rotationally-fixed manner on the first rotational element 7, can be tilted by a predetermined angle about the axis of rotation 71 of the first rotational element 7.

For this purpose, the end part 45 of the driver 44 is preferably formed spherical. A special embodiment variant of the formation of the spherical end 45 of the driver 44 is shown in the top view in FIG. 11. The end part 45 of the driver 44 is mounted and/or accommodated in a formfitting matter in the first or second rotational element 7, 8 in the rotational direction of the first or second rotational element 7, 8. The circumferential contact surfaces of the end part 45 are formed spherical, so that even in the event of an angle offset between the axis of rotation of the first or second rotational element 7, 8 and the longitudinal axis of the driver 44, a rotational movement can be transmitted from the rotational element 7, 8 to the driver 44 and therefore an angle offset is enabled between the bearing axis 4 of the door and the axis of rotation 71 of the first rotational element 7.

It is also conceivable to form the end part of the driver 44 protruding into the door 2 as correspondingly spherical, so that the driver 44 is additionally or alternatively held so it can be tilted in the recess 42 of the door 2.

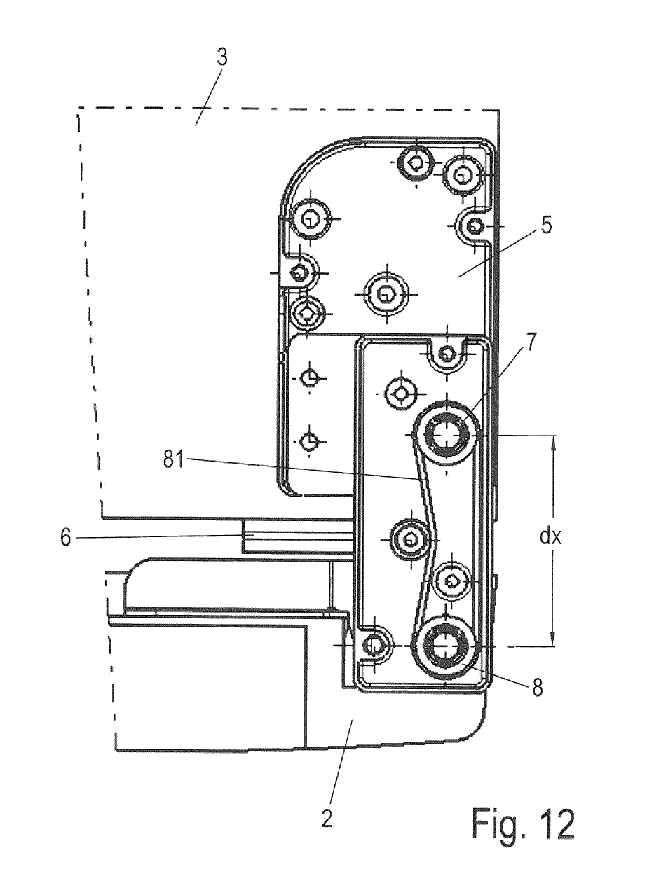

Multiple embodiments of a compensation device are shown in FIGS. 12 to 15, which are capable of compensating for a horizontal offset between the bearing axis 4 of the door 2 and the first rotational element 7 of the closing device 10.

For this purpose, the compensation device according to FIGS. 12 to 15 has at least one second rotational element 8, which is coupled to the first rotational element 7 and transmits the rotational movement, wherein the second rotational element 8 is arranged offset in relation to the first rotational element 7 in a plane substantially parallel to the bearing axis 4. The axis of rotation 84 of the second rotational element 8 is preferably identical to the bearing axis 4 of the door in this case, but can also differ therefrom, for example, upon combination with a driver 9 corresponding to FIGS. 4 to 8, in which the driver 9 is secured to the door 2 outside the axis of rotation 4 of the door 2 and transmits the rotational movement into the second rotational element 8.

In this case, a toothed belt 81 is used to transmit a horizontal axial offset dx, this toothed belt connecting the first rotational element 7 to the second rotational element 8 and using which greater distances between the axes of rotation 4, 71 of the door and the rotational element 7, which drives the closing device 10 or is driven thereby, can also be bridged.

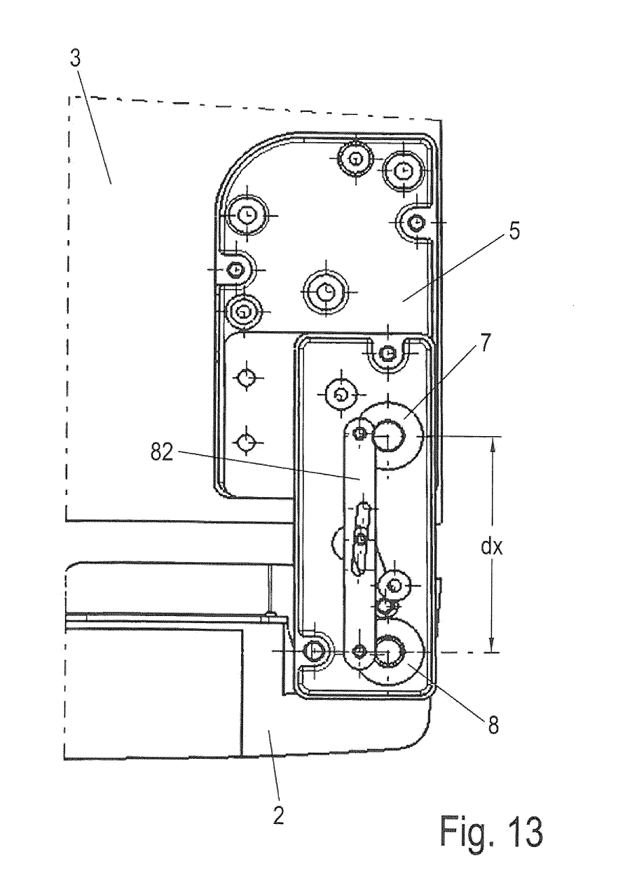

In the embodiment shown in FIG. 13, the first rotational element 7 and the second rotational element 8 are connected to one another via a coupling rod 82, which ensures an equal pivot of the two rotational elements. If the rotational movement is sufficiently large that the dead centers of the rotational elements are traveled over in the 180° extended position by the coupling rod 82, the risk exists of switching over the rotational direction of one rotational element. To prevent this, the coupling rod 82 has an oblong hole, in which a bolt is guided, which is arranged on a pivot lever mounted so it is rotatable on the closing device 10.

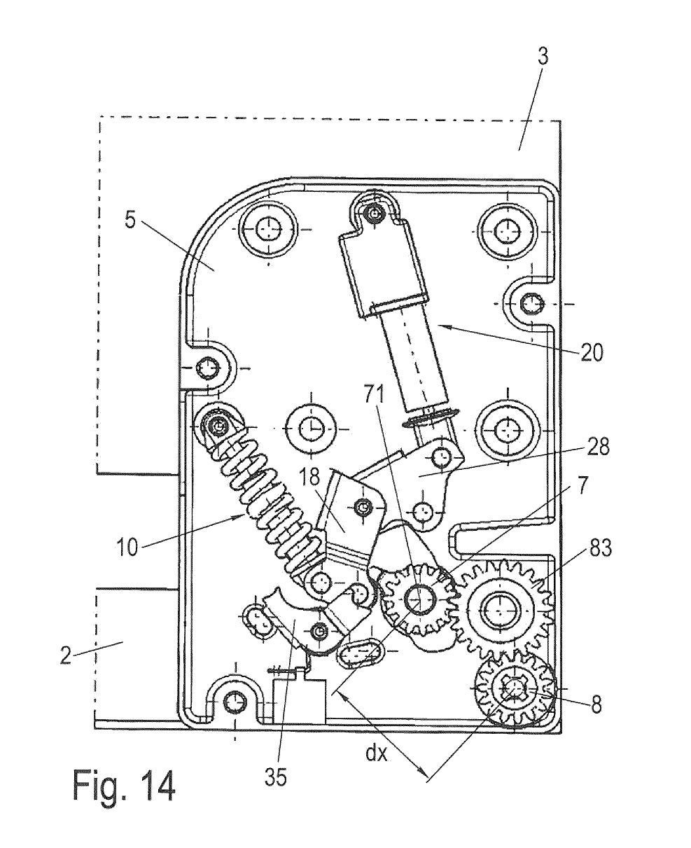

In the embodiment shown in FIG. 14, the first and second rotational elements 7, 8 are designed as gearwheels, which are connected to one another via a third rotational element 83, also designed as a gearwheel, to maintain the rotational direction between the first rotational element 7 and the second rotational element 8.

In this case, the transmission ratio of the door drive in relation to the closing device is defined by the selection of the tooth count of the rotational elements 7, 8, 83.

A ratio of 1:1 is preferably selected in this case, to be able to use the same components for the further components of the closing device as in an embodiment of a closing device in which the first rotational element 7 is not embodied as a gearwheel.

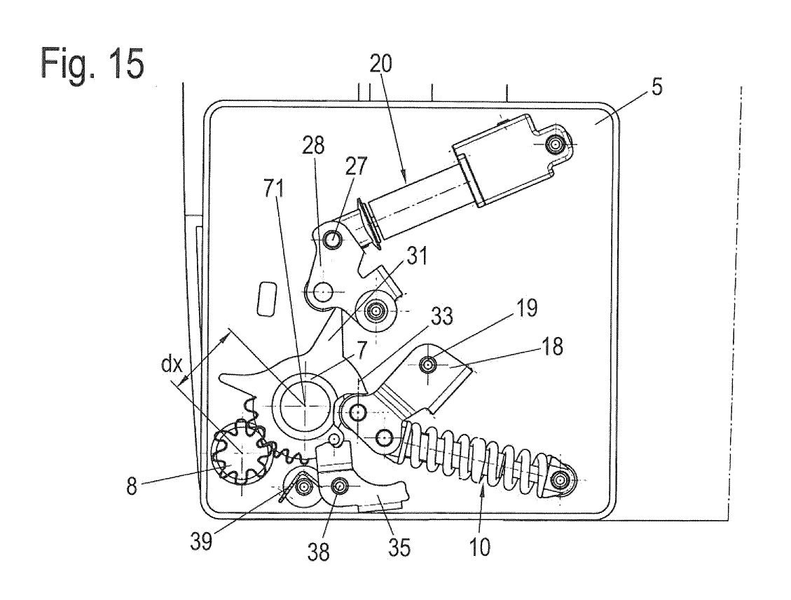

In the embodiment shown in FIG. 15, the first and second rotational elements 7, 8 are also designed as gearwheels, wherein as a result of the reversal of the rotational movement due to only using two gearwheels, the relay of the rotational movement to the closing device 10 and/or from the closing device to the rotational elements 7, 8 is to be ensured here.

However, this reversal of the rotational movement can also intentionally be used for the purpose of reversing the mode of operation of the closing device 10 on the door 2, so that, for example, the door 2 is damped during opening, partially before reaching the end location in the open position, instead of during the closing movement, or also that the opening movement of the door 2 is assisted by the closing device 10.

With appropriate selection of a transmission ratio of the two rotational elements 7, 8 designed as gearwheels, for example, in a transmission ratio of 1:2, the rotational element of the door 2 can be reduced, for example, from 130° to 65° on the first rotational element 7.

An embodiment of the closing device, in which a damper is additionally integrated, will be explained hereafter.

The closing device 10 comprises a spring 11, which is designed as a compression spring and is tensioned between two end parts 12 and 13. A first end part 12 is mounted so it is rotatable about an axis 16 on the housing 5 in this case. On the opposite side, the end part 13 is mounted about an axis 17, which is arranged on a rotatable actuating part 18. The rotatable actuating part 18 is mounted so it is rotatable about the axis 19 on the housing 5. The spring 11 is guided about a sleeve 14 in this case, which can be pushed onto a rod 15, to be able to perform a length compensation between the two end parts 12 and 13.

Furthermore, a damper 20 is provided in the housing 5, which is designed as a linear compression damper having a housing 21 and a piston rod 22. The piston rod 22 is retractable into the housing 21 in this case, wherein upon retraction of the piston rod 22 via a corresponding piston, high damping forces are provided, while the extension of the piston rod 22 takes place smoothly.

The housing 21 is fixed in this case on a holder 24, which is mounted so it is rotatable about an axis 25 on the housing 5. The piston rod 22 is connected at the opposite side via a holder 26 to the pivot part 28, wherein the holder 26 is mounted so it is rotatable about an axis 27. The pivot part 28 is mounted so it is rotatable about the axis 19 on the housing 5 in this case, on which the actuating part 18 is also mounted, wherein the actuating part 18 and the pivot part 28 can be rotated independently of one another about the axis 19.

A curve guide 30, which is arranged in a rotationally-fixed manner on the bearing axis 4, is provided for actuating the closing device 10 and the damper 20. The curve guide 30 comprises multiple control projections 31, 32, and 33, which act on the actuating part 18 and the pivot part 28. For this purpose, a roller 40 is mounted so it is rotatable on the actuating part 18, while a roller 41 is held so it is rotatable on the pivot part 28. Alternatively, the rollers can also be replaced by sliding elements, so that a sequence having the lowest possible friction is ensured between the control projections and the actuating part and/or pivot part 28.

Furthermore, a catch mechanism is provided in the housing 5, to latch the closing device 10 in a tensioned position, wherein the catch mechanism comprises a pivotable pawl 35, which is mounted so it is rotatable about the axis 38 on the housing 5.

If the door 2 is opened out of the closed position, as shown in FIG. 3, the bearing axis 4 thus rotates the curve guide 30 counterclockwise, so that the first control projection 31 acts on the roller 40 to tension the spring 11 of the closing device 10. At the same time, the damper 20 is released in the pivot range between the closed position and an opening angle of between 20° and 60°, in that the control projection 31 is rotated, whereby the pivot part 21 rotates clockwise about the axis 19 until the pivot part 28 comes to a stop on a stop 42 of the housing. The extension of the piston rod 22 out of the housing 21 and the pivoting of the pivot part 28 linked thereto take place in this case by means of the force of a spring 23, which is arranged between the holder 26 and the holder 24.

During the opening of the door 2, the damper 20 between the holder 24 and the holder 26 initially does not change its length if the closing device 10 is tensioned further, in that the control projection 31 acts on the roller 40 and at the same time rotates the actuating part 18 further clockwise, to compress the spring 11 of the closing device 10.

During the opening of the door between an opening angle of 35° and 50°, a control curve 34 of the catch mechanism additionally engages with an arm 37 of the pawl 35, so that it is rotated about the axis 38. A second arm 36 of the pawl 35, which is essentially V-shaped, is thus pivoted toward the actuating part 18. The control curve 34 rotates the pawl 35 against the force of a spring 39 in this case, which pre-tensions the pawl 35 in its unlocked position.

If the door 2 is pivoted further in the opening direction, the arm 36 engages with the end part 13 to latch the closing device 10. The control curve 34 now leaves the arm 37, wherein the control projection 31 is designed so that the spring 11 relaxes slightly upon latching, to latch on the arm 36, so that the roller 40 can be lifted off of the control projection 31.

If the door 2 is moved further in the opening direction, for example, up to an opening angle of approximately 100°, the door 2 moves freely, i.e., neither the closing device 10 nor the damper 20 exerts closing or opening forces on the door 2. This is because the closing device 10 is latched on the pawl 35 and remains stationary, while the damper 20 presses against the stop 42 and is also arranged so it is stationary.

If the door 2 is moved further in the opening direction, a further control projection 33 of the curve guide 30 engages with the pivot part 28 and/or the roller 41 to rotate the pivot part 28 counterclockwise. The damper 20 is thus compressed and the piston rod 22 retracts into the housing 21, whereby damping forces are generated. During a movement from an opening angle of approximately 155° up to the maximum opening position of approximately 180°, the damper 20 is thus compressed. The closing device 10 is still in the latched position and therefore does not exert any forces on the door 2. Opening angles may vary from about 90° to 180°.

If the door 2 is now moved from the maximum opening position in the closing direction, firstly the damper 20 is expanded again from the compressed position, wherein the movement is performed by the spring 23, so that the user does not perceive any forces due to the extension of the damper 20 during the closing of the door 2. The door 2 is now moved further in the closing direction until, at an opening angle of approximately 60° to 70°, the control projection 31 comes into contact against the roller 40 of the actuating part 18 and simultaneously the control curve 34 strikes the arm 37 of the pawl 35. Due to a slight compression of the spring 11 of the closing device 10 and a pivot of the pawl 35 by the control curve 34, the pawl can be moved into the unlocked position, in that the pawl 35 is pivoted about the axis 38 by the force of the spring 39.

If the door 2 is now moved further in the closing direction, at a closing angle between 20° and 60°, the control projection 31 engages with the roller 41 to pivot the pivot part 28 counterclockwise and thus move the damper 20 into the compressed position. Damping forces are thus also generated during the closing of the door 2. At the same time, the closing device 10 is active, because it was unlocked via the control curve 34, so that now the spring 11 rotates the actuating part 18 counterclockwise about the axis 19, wherein the roller 40 runs on the rear side of the control projection.

If the door 2 is closed beyond an angle of 0° as a result of manufacturing tolerances, this is also possible using the bearing assembly shown, wherein a further control projection 32 is provided for this purpose on the control curve to keep the maximum closing forces low.

In the embodiment shown, the actuating part 18 of the closing device 10 and the pivot part 28 of the damper 20 are partially actuated via the same control projections 31 which form a shared control curve. Of course, it is also possible to provide two separate control curves on the bearing axis 4, wherein one control curve is exclusively responsible for the actuating part 18 and the second control curve is exclusively responsible for the pivot part 28. Furthermore, it is possible that the actuating part 18 and the pivot part 28 are not mounted via a shared axis 19. Each of these components can also have a separate axis.

The shape of the control projections 31, 32, and 33 can be adapted to the respective intended use. For example, it is possible to make the damping forces greater in an angle range shortly before reaching the maximum closed position than in an opening range between 20° and 30°. In addition, the spring 11 of the closing device can also be controlled via the curve guide 30 so that the closing forces are kept low in the closed position, to keep the forces on the seals low, while the closing forces are made greater in a slightly open range.

Depending on the embodiment, the bearing axis 4 can be embodied as a separate bearing axis. That is to say, the bearing axis is already attached in the door during the installation, for example, and the bearing assembly is plugged onto the bearing axis, so that the bearing axis is indirectly connected to the curve guide.

The described bearing assembly can be used on a right or left side of an item of furniture or domestic appliance 1, without special right or left components being required.

It is also conceivable to fasten the closing device 10 on or in the door, wherein the drivers 9, 44 have to be supported on the body 3 of the item of furniture in this case.

1. A bearing assembly for a door of an item of furniture or domestic appliance having
a bearing element for the mounting of the door on a body of the item of furniture or domestic appliance so it is rotatable about a bearing axis,
a closing device fastened on the body of the item of furniture or domestic appliance or on the door, by means of which the door is movable by a drive part over a specific predetermined pivot range in the closing direction and/or opening direction,
wherein the closing device has the drive part and a first rotational element, which absorbs the rotational movement of the door about the bearing axis, having an axis of rotation substantially parallel to the bearing axis of the door,
wherein the first rotational element and the door are coupled to one another via a compensation device to compensate for a length offset and/or angle offset between the axis of rotation of the first rotational element and the bearing axis of the door;
wherein
in the closing direction, a damper for damping a pivot movement of the door during the opening and closing of the door over at least one pivot range is accommodated, which is coupled to the first rotational element.

2. The bearing assembly according to claim 1, wherein the compensation device has a driver, which can be coupled to the first rotational element in a rotationally-fixed manner and moves the door in the closing direction and opening direction.

3. The bearing assembly according to claim 1, wherein the compensation device has at least one second rotational element, which is coupled to the first rotational element and transmits the rotational movement, wherein the second rotational element is arranged offset in relation to the first rotational element in a plane substantially parallel to the bearing axis.

4. The bearing assembly according to claim 3, wherein an axis of rotation of the second rotational element is identical to the bearing axis of the door.

5. The bearing assembly according to claim 3, wherein the compensation device has a driver, which can be coupled to the second rotational element in a rotationally-fixed manner and moves the door in the closing direction and/or opening direction.

6. The bearing assembly according to claim 2, wherein the driver has a bolt, which can be coupled to the first rotational element or the second rotational element in a rotationally-fixed manner.

7. The bearing assembly according to claim 6, wherein a driver arm of the driver is held so it can be tilted on the bolt in an angle range between 75° and 105° in relation to the axis of rotation of the first or second rotational element.

8. The bearing assembly according to claim 2, wherein the driver is insertable into a recess of the door.

9. The bearing assembly according to claim 2, wherein the driver is designed as a bolt which can be accommodated in the bearing element of the door so it is rotationally-fixed in relation to the door.

10. The bearing assembly according to claim 9, wherein an end part of the driver which protrudes into the first or second rotational element and/or an end part of the driver which protrudes into the door can be tilted by a predetermined angle about the axis of rotation of the first or second rotational element.

11. The bearing assembly according to claim 10, wherein the end part of the driver which protrudes into the first or second rotational element and/or the end part of the driver which protrudes into the door is mounted in a formfitting manner in the rotational direction of the first or second rotational element wherein circumferential contact surfaces of the end part of the driver are designed as spherical.

12. (canceled)

13. The bearing assembly according to claim 1, wherein a curve guide for moving the closing device and/or the damper is arranged on the first rotational element.

14. The bearing assembly according to claim 1, wherein the closing device is accommodated in a housing.

15. The bearing assembly according to claim 3, wherein the first rotational element is coupled to the second rotational element via a third rotational element.

16. The bearing assembly according to claim 3, wherein the first rotational element is coupled to the second rotational element via a toothed belt.

17. The bearing assembly according to claim 3, wherein the first rotational element is coupled to the second rotational element via a coupling rod.

18. A refrigerator or freezer, having at least one pivotable door, which is held via at least one bearing assembly according to claim 1 on a body of the refrigerator or freezer.

19. The refrigerator or freezer according to claim 18, wherein the bearing assembly is secured on an outer side of the body.
